(19) United States
(12) Patent Application Publication
(10) Pub. No.: US 2018/0205689 A1
(43) Pub. Date: Jul. 19, 2018

(54) MESSAGE CAPTURE FOR MESSAGING SYSTEM

(71) Applicant: Actiance, Inc., Redwood City, CA (US)

(72) Inventors: Jae KIM, Castro Valley, CA (US); Jayachandran BALACHANDRAN, San Mateo, CA (US)

(73) Assignee: Actiance, Inc., Redwood City, CA (US)

(21) Appl. No.: 15/870,791

(22) Filed: Jan. 12, 2018

Related U.S. Application Data
(60) Provisional application No. 62/446,110, filed on Jan. 13, 2017.
(60) Provisional application No. 62/453,955, filed on Feb. 2, 2017.

(51) Int. Cl. H04L 12/58

(52) U.S. Cl. CPC H04L 51/14; H04L 67/28

(57) ABSTRACT

Provided are methods, systems, and computer-program products for providing a modified library file associated with a messaging application server. The modified library file can implement a messaging application that includes an additional operation of sending messages to a remote server. In some examples, the communications can be text messages that are sent over the Internet or other network. For example, a first device can send one or more text messages to a second device via a messaging application server. The messaging application server can route the one or more text messages to a second device, which can be linked to the first device. The second device can display the one or more text messages. At some point in this process, the one or more text messages can be intercepted and sent to a remote server for storage and analysis.

### CROSS-REFERENCES TO RELATED APPLICATIONS

This application claims priority to U.S. Provisional Patent Application No. 62/446,110 filed on Jan. 13, 2017, entitled “Message Capture For Cross-Platform Messaging System” and U.S. Provisional Patent Application No. 62/453,955 filed on Feb. 2, 2017, entitled “Browser Messaging Application Hosting,” the disclosure of which is hereby incorporated by reference in its entirety for all purposes.

### BACKGROUND OF THE INVENTION

Messaging applications, such as BlackBerry® Messenger™, Facebook™ Messenger, Google Hangouts™, KakaoTalk®, LINE (Line Corporation, Japan), WeChat®, and WhatsApp®, may be used to communicate over the Internet or other type of network. However, such messaging applications may include security mechanisms that may make it difficult for enterprises to monitor communications. For example, some messaging applications may include encryption on communications to prevent interception of the communications. Therefore, there is a need in the art to allow enterprises to capture communications sent and received using messaging applications.

### BRIEF SUMMARY OF THE INVENTION

The present disclosure relates generally to techniques for tracking messages sent or received by a messaging application, and more particularly to tracking messages sent or received by a first messaging application using a second messaging application linked to the first messaging application. The messages may be tracked by providing a modified library file used by a messaging application. The modified library file may correspond to an original library file sent by a messaging application server. For example, the original library file may be modified or replaced with custom code to cause an additional operation to be included with the messaging application. The additional operation may cause the messaging application to send a communication to a remote server in response to the messaging application sending or receiving a message. In some examples, the communication may include the message.

In one illustrative example, a first device may be executing a first messaging application based upon the modified library file described above. The first messaging application may be logged into a first account of a messaging application server. A second device may me executing a second messaging application that is also logged into the first account. The second messaging application may not be executing based upon the modified library file. The second device may send a message to a second account using the second messaging application. The message may be sent through the messaging application server, which sends the message to a third device that has a messaging application logged into the second account. In addition to sending the message to the third device, the messaging application server may also send the message to the first device because the first device is also logged into the first account. When the first device receives the message from the message application server, the additional operation described above may cause the first device to send a communication to a remote server, the communication including the message.

In some examples, the remote server may monitor whether a messaging application (executing based upon the modified library file) loses contact with the remote server. In such examples, the remote server may cause another messaging application linked to the messaging application (according to the remote system) to be disabled. The disabling process may be performed to prevent a device from using a messaging application when the remote server is not receiving messages sent or received by the messaging application. Prior to disabling, a notification may be sent to a user that indicates the messaging application is not properly communicating with the remote server.

Numerous benefits are achieved by way of the present disclosure over conventional techniques. For example, embodiments of the present disclosure provide access by a remote server to messages as they are being displayed to a user. The embodiments also provide a method to send and receive messages programmatically, allowing developers to develop messaging bots. Using programmatic message sending, disclaimer messages can be sent automatically to remind the messaging participants of the fact that the messages are being monitored at the beginning of conversation. Embodiments of the present disclosure also provide a way to receive messages and programmatically respond to the incoming messages depending on the messaging command. These and other embodiments of the present disclosure, along with many of its advantages and features, are described in more detail in conjunction with the text below and attached figures.

### BRIEF DESCRIPTION OF THE DRAWINGS

Illustrative embodiments are described in detail below with reference to the following figures:

FIG. 1 illustrates an example of user devices logging into a remote server according to certain embodiments described herein;

FIGS. 2A-2D illustrate an example for configuring a distributed system for message capture using a first type of authentication according to certain embodiments described herein;

FIGS. 3A-3C illustrate an example for configuring a distributed system for message capture using a second type of authentication according to certain embodiments described herein;

FIG. 4 is a simplified flowchart depicting processing performed for sending a modified library file to a device according to certain embodiments described herein;

FIG. 5 illustrates an example of communication of a message in a distributed system according to certain embodiments described herein;

FIG. 6 is a simplified flowchart depicting processing performed for configuring a messaging application to send messages to a remote server according to certain embodiments described herein;

FIG. 7 illustrates an example of disabling a messaging application in a distributed system according to certain embodiments described herein;

FIG. 8 is a simplified flowchart depicting processing performed for responding to a loss of connection between a first messaging application and a remote server according to certain embodiments described herein; and

FIG. 9 illustrates an example of a computer system according to certain embodiments described herein.

### DETAILED DESCRIPTION OF THE INVENTION

In the following description, for the purposes of explanation, specific details are set forth in order to provide a thorough understanding of embodiments of this disclosure. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of this disclosure as set forth in the appended claims.

Messaging applications, such as BlackBerry® Messenger™, Facebook™ Messenger, Google Hangouts™, KakaoTalk®, LINE (Line Corporation, Japan), WeChat®, and WhatsApp®, can be used to communicate over the Internet or other type of network. However, such messaging applications can include security mechanisms that may make it difficult for enterprises to monitor communications. For example, some messaging applications may include encryption on communications to prevent interception of the communications.

The present disclosure relates generally to techniques for tracking messages sent or received by a messaging application, and more particularly to tracking messages sent or received by a first messaging application using a second messaging application linked to the first messaging application. The messages may be tracked by providing a modified library file used by a messaging application. The modified library file may correspond to an original library file sent by a messaging application server. For example, the original library file may be modified or replaced with custom code to cause an additional operation to be included with the messaging application. The additional operation may cause the messaging application to send a communication to a remote server in response to the messaging application sending or receiving a message. In some examples, the communication may include the message.

In one illustrative example, a first device may be executing a first messaging application based upon the modified library file described above. The first messaging application may be logged into a first account of a messaging application server. A second device may be executing a second messaging application that is also logged into the first account. The second messaging application may not be executing based upon the modified library file. The second device may send a message to a second account using the second messaging application. The message may be sent through the messaging application server, which sends the message to a third device that has a messaging application logged into the second account. In addition to sending the message to the third device, the messaging application server may also send the message to the first device because the first device is also logged into the first account. When the first device receives the message from the message application server, the additional operation described above may cause the first device to send a communication to a remote server, the communication including the message.

In some examples, the remote server may monitor whether a messaging application (executing based upon the modified library file) loses contact with the remote server. In such examples, the remote server may cause another messaging application linked to the messaging application (according to the remote system) to be disabled. The disabling process may be performed to prevent a device from using a messaging application when the remote server is not receiving messages sent or received by the messaging application. Prior to disabling, a notification may be sent to a user that indicates the messaging application is not properly communicating with the remote server.

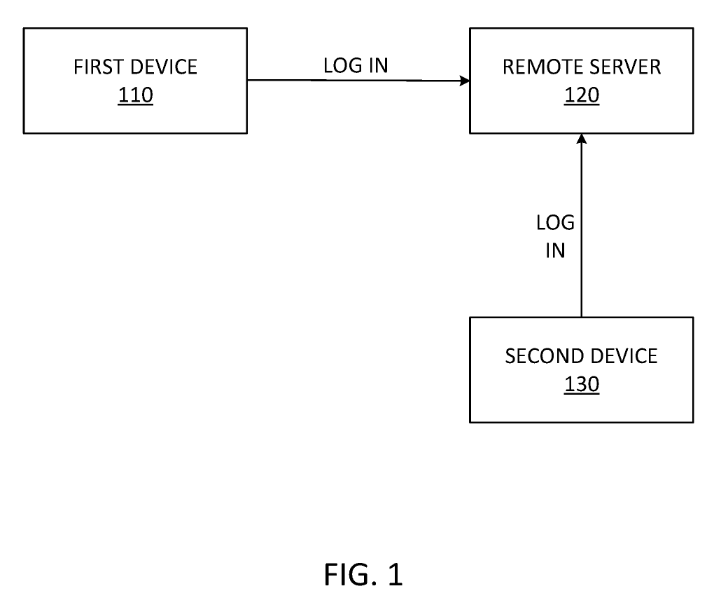

FIG. 1 illustrates an example of user devices (i.e., first device 110 and second device 130) logging into remote server 120 according to certain embodiments described herein. The user devices may log into remote server 120 using a username (e.g., an employee identification) and, in some examples, one or more authentication credentials (e.g., a password). For illustrative purposes, the user devices may log into remote server 120 through a web page navigated to by the user devices or an application executing on the user devices.

A user device may log into remote server 120 so that remote server 120 can associate multiple user devices together. For example, each of first device 110 and second device 130 may log into remote server 120 using a first username. In response, remote server 120 may associate first device 110 with second device 130.

In other examples, remote server 120 may receive a list of user devices that are linked together such that the user devices do not need to log into remote server 120. In such examples, the list may include identifications (e.g., Internet Protocol (IP) addresses or media access control (MAC) addresses) of the user devices. It should be recognized that other methods may be used to ensure that remote server 120 may properly associate devices together.

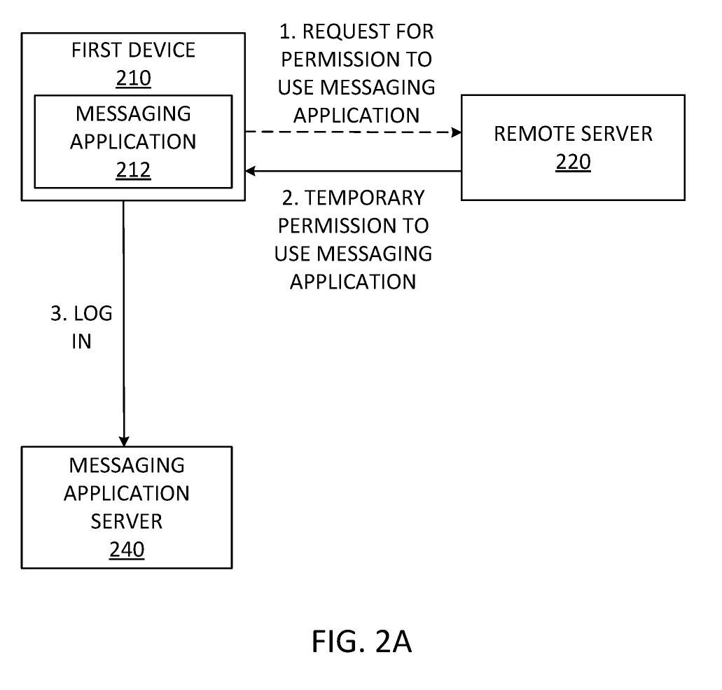

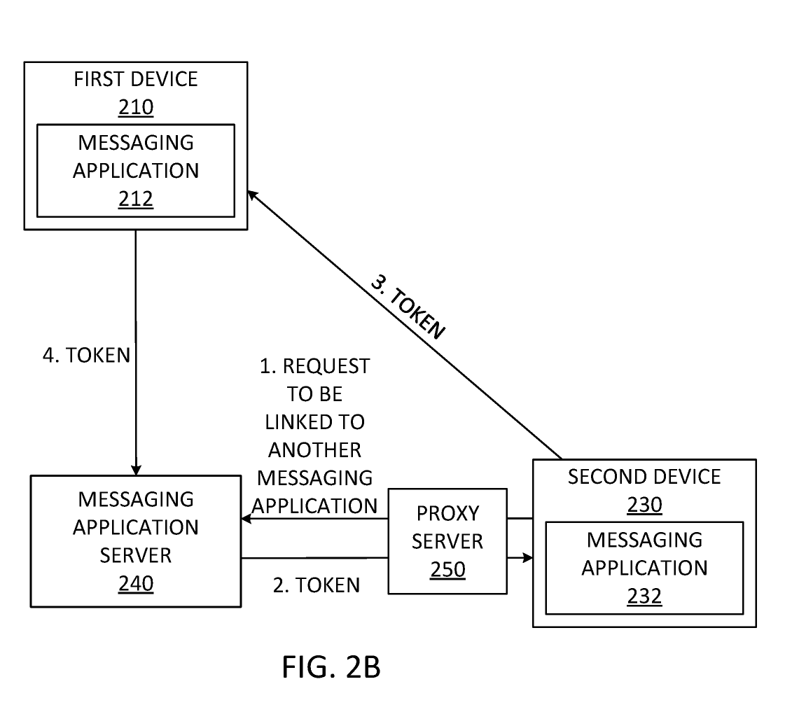

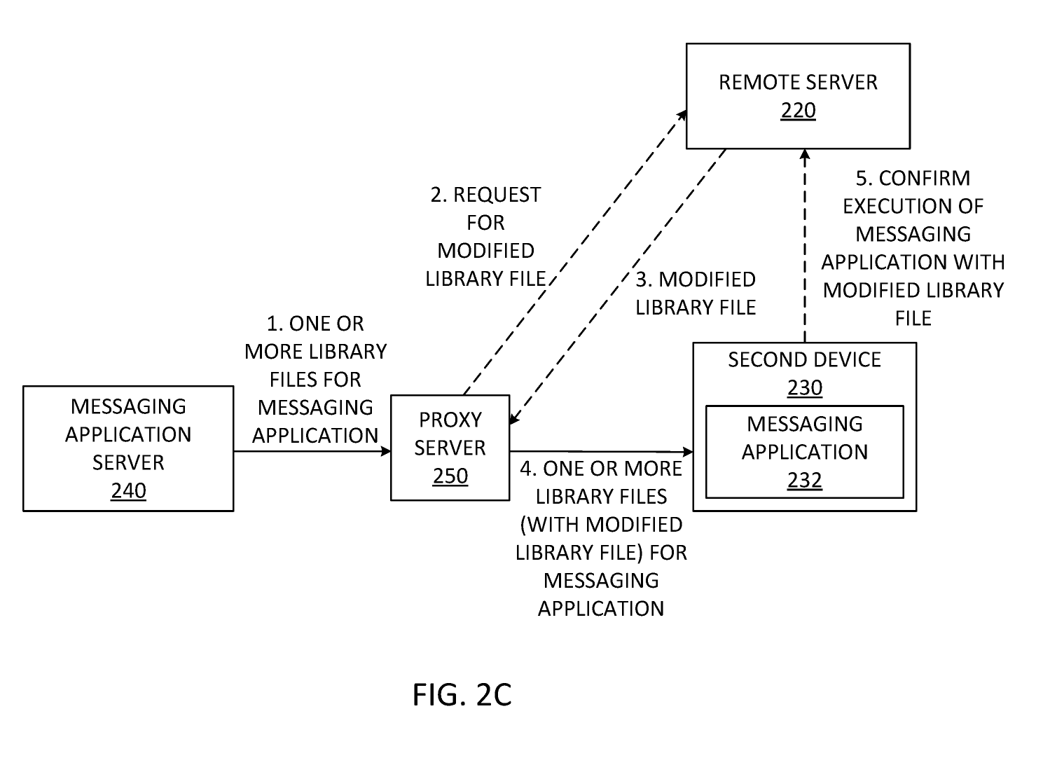

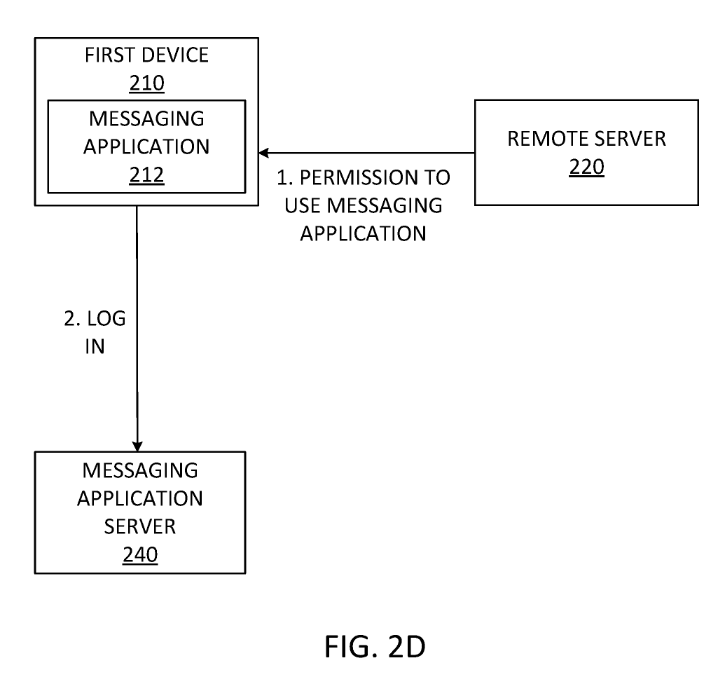

FIGS. 2A-2D illustrate an example for configuring a distributed system for message capture using a first type of authentication according to certain embodiments described herein. The first type of authentication is based upon a first device authenticating with a system and a second device using the first device's authentication to authenticate with the system. An example of such a system is WeChat; however, it should be recognized that other systems use a similar type of authentication.

FIG. 2A illustrates a process for first device 210 logging into messaging application server 240 according to certain embodiments described herein. First device 210 may be executing messaging application 212 in order to log into messaging application server 240. First device 210 may be a mobile phone, laptop, desktop computer, server, or other type of computing device. Messaging application 212 may be a web application, a device application, or other type of code executing on first device 210.

In some examples, to begin the logging-into process, first device 210 may send a request for permission to use messaging application 212 to remote server 220. Remote server 220 may be associated with an enterprise that is tasked with managing first device 210. For example, the enterprise may be a company that issued first device 210 to an employee of the company. While remote server 220 is indicated to be a server, it should be recognized that remote server 220 may be one or more servers and/or one or more devices that make up a system.

In response to the request, remote server 220 may grant temporary permission for first device 210 to use messaging application 212. In some examples, granting the temporary permission may include remote server 220 sending a communication to a device manager included with first device 210. The communication may cause the device manager to allow first device 210 to use messaging application 212.

In other examples, granting the temporary permission may not include an actual communication sent to first device 210. Instead, granting the temporary permission may cause remote server 220 to not send a communication to the device manager to cause first device 210 to disable messaging application 212.

It should be recognized that the request does not need to be sent for remote server 220 to grant the temporary permission. For example, remote server 220 may automatically grant temporary permission to devices for a particular amount of time or until a particular event occurs.

Once first device 210 has been granted temporary permission to use messaging application 212 (or messaging application 212 has not been disabled), first device 210 may log into messaging application server 240 using messaging application 212. By logging into messaging application server 240, messaging application 212 may send messages to and receive messages from messaging applications on other devices through messaging application server 240. While the method of logging into messaging application server 240 may vary between different messaging application servers, it should be recognized that logging in should include some type of authentication process. The authentication process may include messaging application 212 providing a username and/or password to messaging application server 240.

Messaging application server 240 may facilitate communication of messages between messaging applications. Messaging application server 240 may be for BlackBerry Messenger, Facebook Messenger, Google Hangouts, KakaoTalk, LINE, WeChat, WhatsApp, or the like. In some examples, messaging application server 240 may be cross platform, such that messaging application server 240 facilitates communications to multiple types of devices, such as mobile devices, desktop computers, gaming consoles, or the like. For example, messaging application server 240 may receive communications from a mobile device to send to a desktop computer.

FIG. 2B illustrates a process for authenticating second device 230 with messaging application server 240 according to certain embodiments described herein. The process illustrated in FIG. 2B may occur after the process illustrated in FIG. 2A.

The authenticating illustrated in FIG. 2B may begin when second device 230 sends a request to be linked to another messaging application. Linking a first messaging application with a second messaging application may cause each messaging application receive messages sent and received by the other messaging application. The request may be sent to messaging application server 240 using messaging application 232. Messaging application 232 may be a web application, a device application, or other type of code executing on second device 230.

Messaging application 232 may be the same type of messaging application or a different type of messaging application as messaging application 212. For example, messaging application 212 may be a mobile-based messaging application and messaging application 232 may be a browser-based messaging application.

In some examples, the request may be sent to messaging application server 240 through proxy server 250 due to second device 230 being on a network that must send communications through proxy server 250 in order to have the communications leave the network. Proxy server 250 may monitor communications sent from inside to outside and outside to inside of the network. In some examples, communications within the network are not monitored by proxy server 250. In other examples, all communications associated with the network are monitored by proxy server 250. First device may be located either inside or outside of the network.

In response to the request, messaging application server 240 may send a token to messaging application 232. The token may include an identification of messaging application 232 (which is requesting the messaging applications to be linked), messaging application 212 (which is already authenticated), a unique identification for the linking process, or the like. Similar to communications being sent from inside to outside of the network, the token may be first received by proxy server 250, which sends the token to messaging application 232.

Messaging application 232 may send the token to messaging application 212. For example, a user operating second device 230 may cause a communication with the token to be sent to messaging application 212. For another example, messaging application 232 may display the token such that a user operating messaging application 212 may input the token into messaging application 212. For another example, the token may be represented by a quick response (QR) code. In such an example, messaging application 232 may display the QR code so that first device 210 may scan the QR code. By scanning the QR code, first device 210 may identify the token and send the token to messaging application 212. When the token is received by messaging application 212 (e.g., by one of the examples described above), messaging application may send the token to messaging application server 240. By transferring the token from messaging application server 240 to messaging application 232 to messaging application 212 and back to messaging application server 240, the authentication of messaging application 212 may be used to authenticate messaging application 232.

For another example, the QR code may encode a uniform resource identifier (URI) (e.g., uniform resource locator (URL) or uniform resource name (URN)). When the QR code encodes a URI, first device 210 may navigate to a destination represented by URI when the QR code is scanned. The destination may cause a communication to be sent to messaging application server 240 indicating that second device 230 should be authenticated. It should be recognized that messaging application server 240 may be authenticated using the authentication of messaging application 212 in other ways than described above.

FIG. 2C illustrates a process for providing one or more library files to second device 230. The process illustrated in FIG. 2C may occur after the process illustrated in FIG. 2B. The process may begin when messaging application server 240 sends one or more library files to second device 230. The one or more library files may be used to execute messaging application 232. As described above, because messaging application server 240 is not within a network that includes second device 230, the one or more library files may be first received by proxy server 250.

Based upon receiving the one or more library files, proxy server 250 may determine that second device 230 is attempting to execute messaging application 232. In some examples, proxy server may send a request for a modified library file to remote server 220. The request may include an identification of second device 230. Remote server 220 may respond to the request with the modified library file for second device 230. In other examples, proxy server 250 may have stored the modified library file such that proxy server 250 does not need to send the request to remote server 220.

Once proxy server 250 has the modified library file, proxy server 250 may replace a library file in the one or more library files with the modified library file, the library file corresponding to the modified library file. Proxy server 250 may then send the one or more library files (with the modified library file) to second device 230. In other examples, proxy server 250 may send the modified library file with the one or more library files without replacing a library file. In other examples, the modified library file may be for a separate process that is configured to execute along with messaging application 232 to perform the operations described herein. When the modified library file is a separate process, the separate process may perform the operations described herein rather than messaging application 232.

Using the received one or more library files, second device 230 may execute messaging application 232 such that messaging application 232 is executing based upon the modified library file. The modified library file may include one or more additional operations not included in the corresponding library file. For example, the modified library file may include an operation that causes messaging application 232 to send a communication to remote server 220 in response to any messages being sent or received by messaging application 232. The communication may include information associated with the messages being sent or received by messaging application 232. For example, the communication may include the messages. When a message is sent by messaging application 232 to messaging application server 240, the communication sent to remote server 220 may be additional. When a message is received by messaging application 232 from messaging application server 240, the communication sent to remote server 220 may occur after messaging application server 240 sends the message to messaging application 232. In such examples, the message sent to remote server 220 may be in a readable format (e.g., unencrypted).

In some examples, the modified library file may also include an operation that causes messaging application 232 (or second device 230) to periodically send communications to remote server 220 to confirm that a connection between second device 230 and remote server 220 is still active.

In some examples, after second device 230 executes messaging application 232 based upon the modified library file, second device 230 may send a confirmation message to remote server 220 that indicates messaging application 232 is executing with the modified library file. In other examples, the pinging of remote server 220 by messaging application 232 due to the modified library file may serve as the confirmation message.

After remote server 220 determines that a communication channel has been established between messaging application 232 and remote server 220, remote server 220 may grant permission for first device 210 to use messaging application 212, as illustrated in FIG. 2D. The permission granted after the communication channel has been established may be different than the temporary permission granted in FIG. 2A. In particular, the permission may be revocable when remote server 220 determines that the communication channel is inactive. Remote server 220 may determine that the communication channel is inactive when remote server 220 does not receive a communication from messaging application 232 for a particular amount of time (i.e., the periodic pinging is no longer being received by remote server 220). For illustrative purposes, the particular amount of time may correspond to the time remote server 220 would expect one or more periodic pings from messaging application 232.

In some examples, granting the permission may include remote server 220 sending a communication to the device manager included with first device 210. The communication may cause the device manager to allow first device 210 to use messaging application 212.

In other examples, granting the permission may not include an actual communication sent to first device 210. Instead, granting the temporary permission may cause remote server 220 to not send a communication to the device manager to cause first device 210 to disable messaging application 212. Remote server 220 may then send a communication to the device manager to cause first device 210 to disable messaging application 212 when remote server 220 determines that the communication channel is inactive.

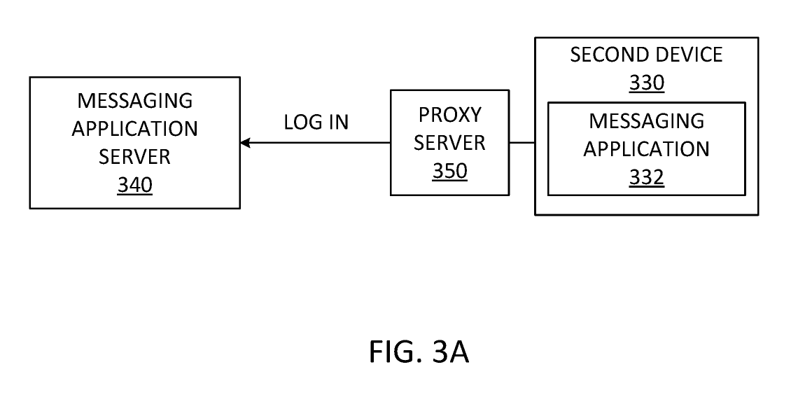

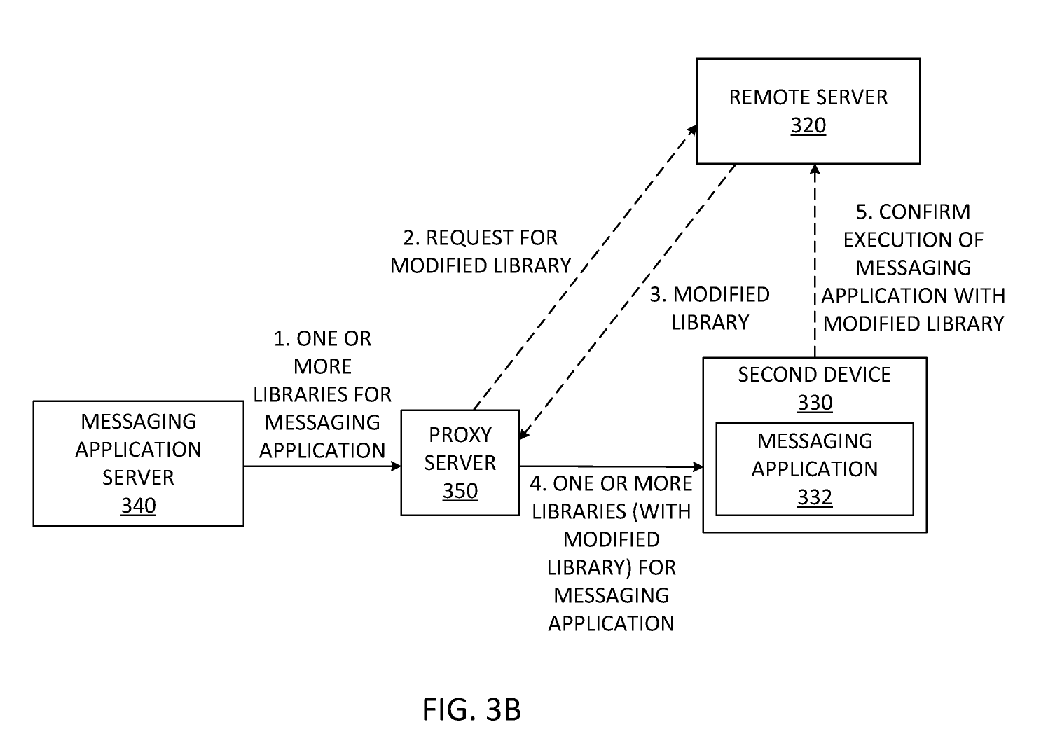

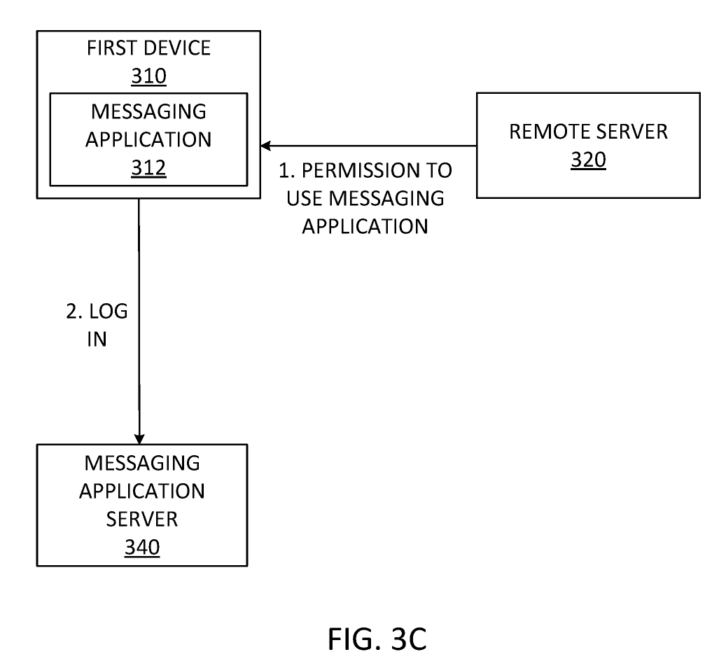

FIGS. 3A-3C illustrate an example for configuring a distributed system for message capture using a second type of authentication according to certain embodiments described herein. As described above, the second type of authentication is based upon each of a first device and a second device separately authenticating the same account with a system. An example of such a system is Facebook Messenger; however, it should be recognized that other systems use a similar type of authentication.

FIG. 3A illustrates a process for second device 330 logging into messaging application server 340 according to certain embodiments described herein. Second device 330 may be executing messaging application 332 in order to log into messaging application server 240. Second device 330 may be a mobile phone, laptop, desktop computer, server, or other type of computing device. Messaging application 332 may be a web application, a device application, or other type of code executing on second device 330.

Because second device 330 may separately authenticate from first device 310 in this type of authentication, first device 310 does not need to send a request for permission to use messaging application 312 to remote server 320 (as described above in FIG. 2A). Instead, second device 330 may log into messaging application server 340 using messaging application 332. By logging into messaging application server 340, messaging application 332 may send and receive messages from messaging applications on other devices through messaging application server 340. While the method of logging into messaging application server 340 may vary between different messaging application servers, it should be recognized that logging in should include some type of authentication process. The authentication process may include messaging application 332 providing a username and/or password to messaging application server 340. And as described above, messages sent from inside to outside or outside to inside of a network including second device 330 may go through proxy server 350.

FIG. 3B illustrates a process for providing one or more library files to second device 330. The process illustrated in FIG. 3B may occur after the process illustrated in FIG. 3A. The process may begin when messaging application server 340 sends one or more library files to second device 330. The one or more library files may be used to execute messaging application 332. As described above, because messaging application server 340 in not within a network that includes second device 330, the one or more library files may be first received by proxy server 350.

Based upon receiving the one or more library files, proxy server 350 may determine that second device 330 is attempting to execute messaging application 332. In some examples, proxy server may send a request for a modified library file to remote server 320. The request may include an identification of second device 330. Remote server may respond to the request with the modified library file for second device 330. In other examples, proxy server 350 may have stored the modified library file such that proxy server 350 does not need to send the request to remote server 320.

Once proxy server 350 has the modified library file, proxy server 350 may replace a library file in the one or more library files with the modified library file, the library file corresponding to the modified library file. Proxy server 350 may then send the one or more library files (with the modified library file) to second device 330. In other examples, proxy server 350 may send the modified library file with the one or more library files without replacing a library file. In other examples, the modified library file may be for a separate process that is configured to execute along with messaging application 332 to perform the operations described herein. When the modified library file is a separate process, the separate process may perform the operations described herein rather than messaging application 332.

Using the received one or more library files, second device 330 may execute messaging application 332 such that messaging application 332 is executing based upon the modified library file. The modified library file may include one or more additional operations not included in the corresponding library file. For example, the modified library file may include an operation that causes messaging application 332 to send a communication to remote server 320 in response to any messages being sent or received by messaging application 332. The communication may include information associated with the messages being sent or received by messaging application 332. For example, the communication may include the messages. When a message is sent by messaging application 332 to messaging application server 340, the communication sent to remote server 320 may be additional. When a message is received by messaging application 332 from messaging application server 340, the communication sent to remote server 320 may occur after messaging application server 340 sends the message to messaging application 332. In such examples, the message sent to remote server 320 may be in a readable format (e.g., unencrypted).

In some examples, the modified library file may also include an operation that causes messaging application 332 (or second device 330) to periodically send communications to remote server 320 to confirm that a connection between second device 330 and remote server 320 is still active.

In some examples, after second device 330 executes messaging application based upon the modified library file, second device 330 may send a confirmation message to remote server 320 that indicates messaging application 332 is executing with the modified library file. In other examples, the pinging of remote server 320 by messaging application 332 due to the modified library file may serve as the confirmation message.

FIG. 3C illustrates a process for messaging application 312 of first device 310 to log into messaging application server 340. The process illustrated in FIG. 3C may occur after the process illustrated in FIG. 3B. The process may begin in response to remote server 220 determining that a communication channel has been established between messaging application 332 and remote server 320. In particular, remote server 320 may grant permission for first device 310 to use messaging application 312. The permission may be revocable when remote server 320 determines that the communication channel is inactive. Remote server 320 may determine that the communication channel is inactive when remote server 320 does not receive a communication from messaging application 332 for a particular amount of time (e.g., the periodic pinging is no longer being received by remote server 320). For illustrative purposes, the particular amount of time may correspond to the time remote server 320 would expect one or more periodic pings from messaging application 332.

In some examples, granting the permission may include remote server 320 sending a communication to the device manager included with first device 310. The communication may cause the device manager to allow first device 310 to use messaging application 312.

In other examples, granting the permission may not include an actual communication sent to first device 310. Instead, granting the temporary permission may cause remote server 320 to not send a communication to the device manager to cause first device 310 to disable messaging application 312. Remote server 220 may then send a communication to the device manager to cause first device 310 to disable messaging application 212 when remote server 220 determines that the communication channel is inactive.

After the permission is granted, messaging application 312 may log into messaging application server 340. By logging into messaging application server 340, messaging application 312 may send messages to and receive messages from messaging applications on other devices through messaging application server 340. While the method of logging into messaging application server 340 may vary between different messaging application servers, it should be recognized that logging in should include some type of authentication process. The authentication process may include messaging application 312 providing a username and/or password to messaging application server 340.

While the above describes messaging application 312 logging into messaging application server 340 in response to the permission being granted, it should be recognized that first device 310 may be granted temporary permission as described above for FIG. 3A. In such examples, messaging application 312 may log into messaging application server 340 before remote server 320 determines that a communication channel has been established between messaging application 332 and remote server 320.

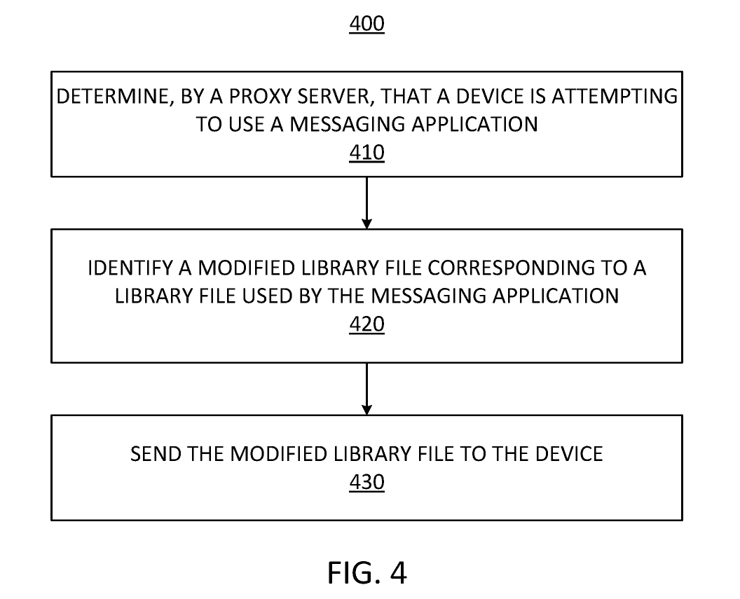

FIG. 4 is a simplified flowchart depicting processing performed for sending a modified library file to a device according to certain embodiments described herein. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain embodiments, the steps may be performed in some different order or some steps may also be performed in parallel.

In the embodiment depicted in FIG. 4, the processing may be triggered at 410 when a proxy server determines that a device is attempting to use a messaging application. The determination may be based upon the proxy server receiving one or more library files used to execute the messaging application. For example, receipt of the one or more library files by the proxy server may indicate to the proxy server that the device is attempting to use the messaging application. In some examples, the messaging application may be executed through a browser executing on the device.

In some examples, the one or more library files may be sent to the proxy server in response to the device authenticating with a messaging application server. In such examples, the one or more library files may be sent by the messaging application server. The authentication of the messaging application server may occur in various ways, including a first type as described above in FIGS. 2A-2C and a second type as described above in FIGS. 3A-3C.

To reiterate the first type, a second device may authenticate a second messaging application with the messaging application server using one or more authentication credentials. After the second device is authenticated, the device may send a request to the messaging application server. The request may be to link the messaging application with the second messaging application such that communications sent and received by the second messaging application are sent to the messaging application. Linking the messaging application may include the messaging application receiving a token from the messaging application server, the second messaging application receiving the token, and the second messaging application sending the token back to the messaging application server. Such linking allows the messaging application to use the authentication of the second messaging application to authenticate itself

To reiterate the second type, the device and the second device may separately authenticate with the messaging application server by each providing one or more authentication credentials.

In either type of authentication, both the messaging application and the second messaging application may be concurrently authenticated for the same account of the messaging application server. By both being associated with the same account, each messaging application may receive messages sent to and/or received by another messaging application authenticated for the same account. For example, the second messaging application, through the messaging application server, may send a message to another messaging application or receive a message from another messaging application the messaging application server. In response to messaging application server sending the message to its destination, the messaging application server may also duplicate the message and send the duplicated message to the messaging application associated with the device.

At 420, the proxy server may identify a modified library file corresponding to a library file used by the messaging application. The modified library file may be configured to cause a first communication to be sent to a remote server in response to one or more first messages being sent or received by the messaging application. In some examples, identifying the modified library file may include obtaining the modified library file from the remote server.

At 430, the proxy server may send the modified file to the device, where the device executes the messaging application using the modified library file. The messaging application may be configured to (1) send and receive one or more messages through a messaging application server and (2) send, due to the modified library file, a second communication to the remote server in response to one or more second messages being sent or received by the messaging application. In some examples, the second communication may include the one or more second messages.

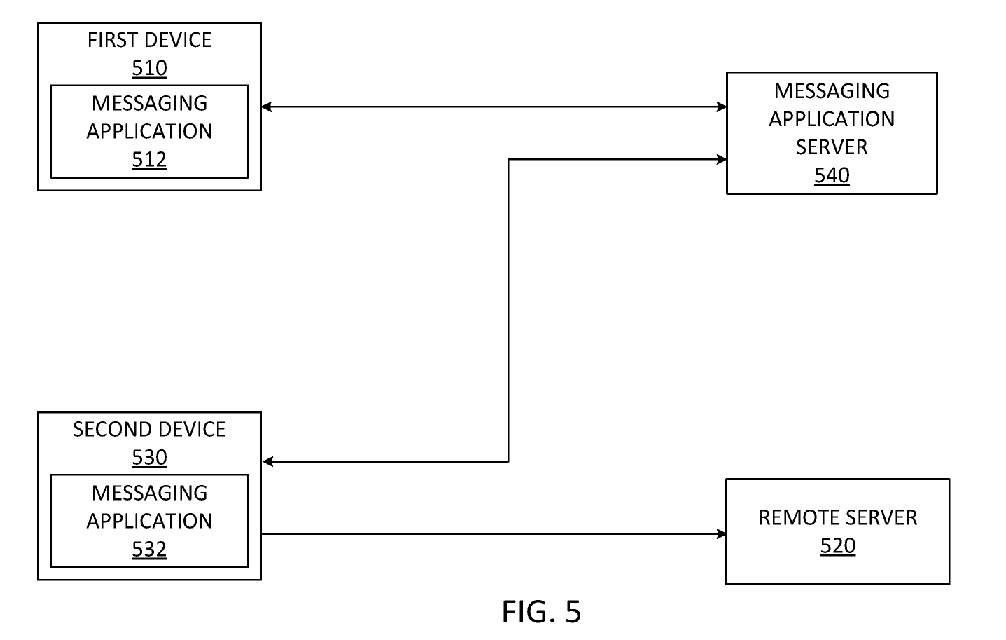

FIG. 5 illustrates an example of communication of a message in a distributed system according to certain embodiments described herein. In some examples, the distributed system may include first device 510, remote server 520, second device 530, and messaging application server 540.

First device 510 may be executing messaging application 512 and second device 53—may be executing messaging application 532. In one illustrative example, first device 510 may be a mobile phone, and messaging application 512 may be a mobile application. In such an example, second device 530 may be a device executing a browser, where messaging application 532 is a browser-based application (e.g., a web page executing on the browser).

Messaging application 512 and messaging application 532 may each be associated with messaging application server 540 such that at least some messages sent by either messaging application 512 or messaging application 532 are first sent to messaging application server 540, which may then send the messages to their destination (e.g., another messaging application associated with messaging application server 540). In some examples, messaging application 512 and messaging application 532 may both be associated with a single account of messaging application server 540 such that messages sent and received by messaging application 512 are sent to messaging applicant 532 (and vice versa).

In some examples, messaging application 532 may be executing based upon a modified library file, as described above. For example, the modified library file may cause messages sent and/or received by messaging application 532 to be sent to remote server 520. The modified library file may correspond to a library file that is typically sent from messaging application server 540 in order to execute messaging application 532.

In some examples, when messaging application 532 receives a communication from messaging application server 540, messaging application 532 may identify a message (based upon the communication) to display. In some examples, the communication may be encrypted such that the communication must be decrypted before the message may be identified.

Once the message is identified, an operation associated with the modified library file may cause messaging application 532 to send a communication including the message to remote server 520.

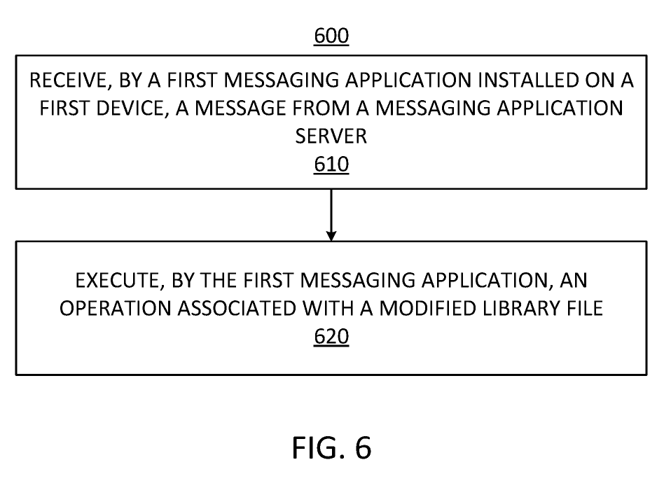

FIG. 6 is a simplified flowchart depicting processing performed for configuring a messaging application to send messages to a remote server according to certain embodiments described herein. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain embodiments, the steps may be performed in some different order or some steps may also be performed in parallel.

In the embodiment depicted in FIG. 6, the processing may be triggered at 610 when a first messaging application executing on a first device receives a message from a messaging application server. The first messaging application may be logged into an account of the messaging application server. The messaging application server may have received the message from a second messaging application executing on a second device. In some examples, the second messaging application is logged into a first account, and the message is sent from the second messaging application to a second account of the messaging application server. In such examples, the second messaging application and the first messaging application may be concurrently logged into the account. In other examples, the second messaging application is logged into a second account of the messaging application server.

At 620, the first messaging application execute an operation associated with a modified library file. The operation may be executed in response to receiving the message. The operation may cause a communication to be sent to a remote server. The modified library file may be a modified version of an original library file provided by the messaging application server, where a difference between the modified library file and the original file is the operation. \

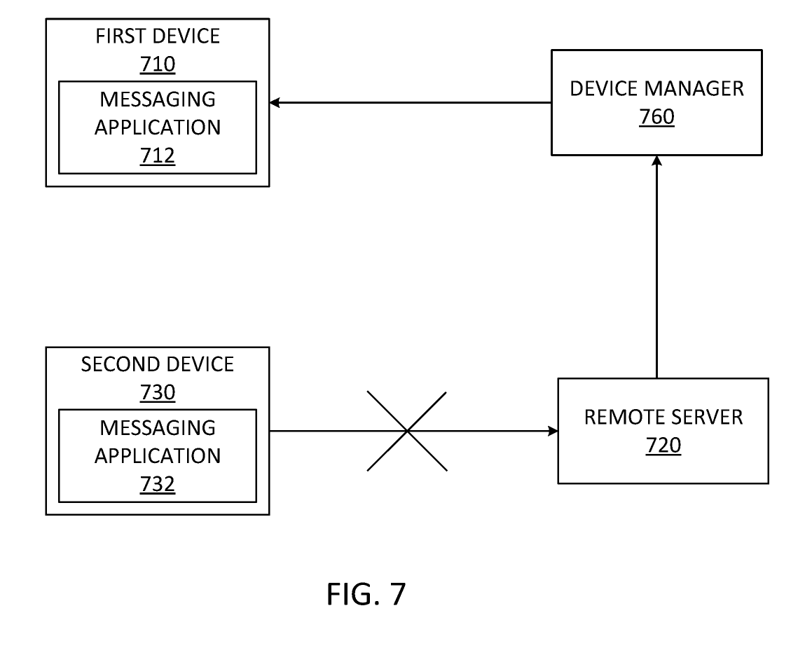

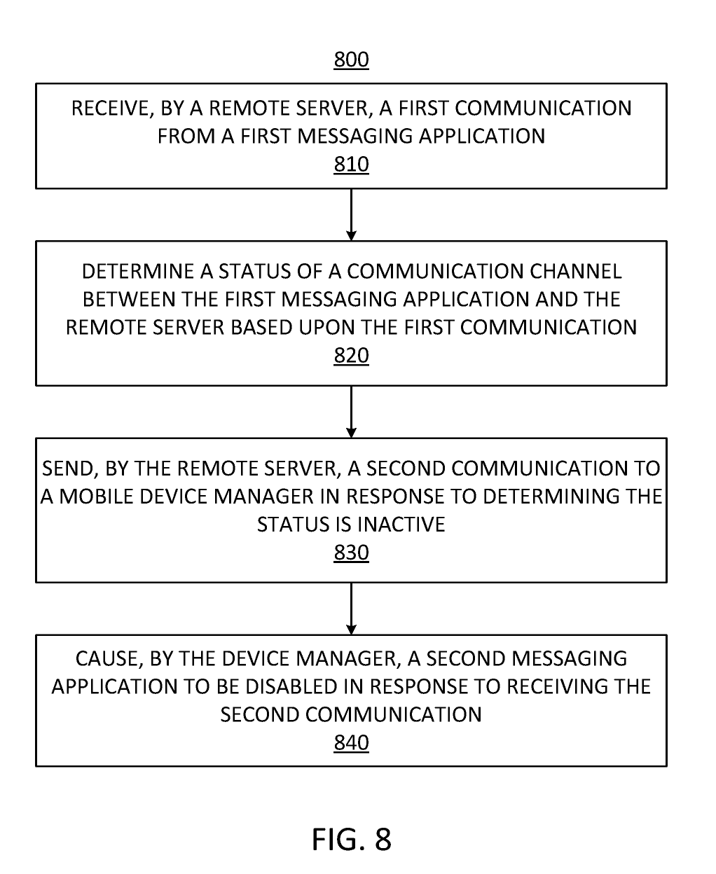

In some examples, the processing depicted in FIG. 6 may further include the first messaging application periodically sending a message to the remote server to indicate a communication channel is active between the first messaging application and the remote server. In such examples, the second messaging application may be disabled when the communication channel is inactive, as further described below with reference to FIGS. 7 and 8.

FIG. 7 illustrates an example of disabling a messaging application in a distributed system according to certain embodiments described herein. The distributed system may include first device 710, remote server 720, second device 730, and device manager 760.

First device 710 may be executing messaging application 712, and second device 730 may be executing messaging application 732. Messaging application 732 may be executing according to a modified library file, as described above. For example, messaging application 732 may periodically send a communication to remote server 720 so that remote server 720 may determine whether a communication channel is active between messaging application 732 and remote server 720. Remote server 720 may also be monitoring communications sent and/or received by messaging application 732.

Device manager 760 (sometimes referred to as an application manager) may enable and/or disable (sometimes referred to as activate or deactivate) one or more applications included on first device 710. For example, disabling may include executing an operation that prevents a user of first device 710 from using an application. While device manager 760 is shown as a separate box, it should be recognized that device manager 760 may be included and executing on first device 710. In other examples, device manager 760 may be executing on remote server 720.

In some examples, remote server 720 may link second device 730 to first device 710 such that when a communication channel between messaging application 732 and remote server 720 is inactive, remote server 720 disables messaging application 712.

FIG. 8 is a simplified flowchart depicting processing performed for responding to a loss of connection between a first messaging application and a remote server according to certain embodiments described herein. The processing depicted in FIG. 8 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 8 and described below is intended to be illustrative and non-limiting. Although FIG. 8 depicts the various processing steps occurring in a particular sequence or order, this is not intended to be limiting. In certain embodiments, the steps may be performed in some different order or some steps may also be performed in parallel.

In the embodiment depicted in FIG. 8, the processing may be triggered at 810 when a remote server receives a communication (referred to as a first communication) from a first messaging application. The first communication may indicate that a communication channel between the first messaging application and the remote server is active. It should be recognized in some examples that the first communication may be never sent (i.e., an active communication is never established between the first messaging application and the remote server).

At 820, the remote server may determine a status of the communication channel between the browser-based messaging application and the messaging application server based upon the first communication. For example, if a particular amount of time has passed since the first communication has arrived (without another communication arriving), the remote server may determine that the communication channel is inactive.

At 830, in response to determining that the communication channel is inactive, the remote server may send a communication (referred to as a second communication) to a device manager. The second communication may cause a second messaging application of a second device to be disable or deactivated. For example, at 840, the device manager may cause the second messaging application to be disabled in response to the device manager receiving the second communication.

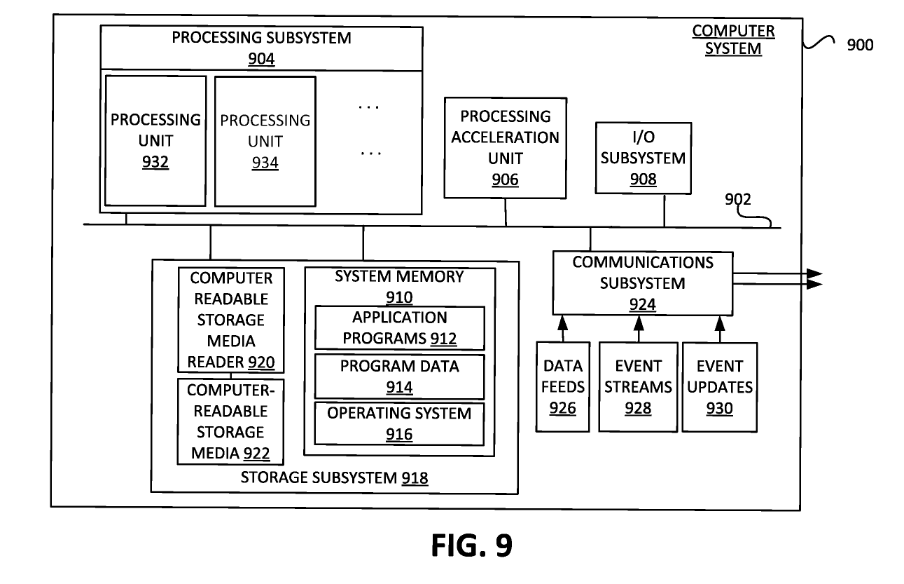

FIG. 9 illustrates an example of computer system 900, which may be used to implement certain embodiments described herein. For example, in some embodiments, computer system 900 may be used to implement any of the systems, servers, devices, or the like described above.

As shown in FIG. 9, computer system 900 includes processing subsystem 904, which communicates with a number of other subsystems via bus subsystem 902. These other subsystems may include processing acceleration unit 906, I/O subsystem 908, storage subsystem 918, and communications subsystem 924. Storage subsystem 918 may include non-transitory computer-readable storage media including storage media 922 and system memory 910.

Bus subsystem 902 provides a mechanism for allowing the various components and subsystems of computer system 900 to communicate with each other. Although bus subsystem 902 is shown schematically as a single bus, alternative embodiments of bus subsystem 902 may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 904 controls the operation of computer system 900 and may comprise one or more processors, application specific integrated circuits (ASICs), or field programmable gate arrays (FPGAs). The processors may include single core and/or multicore processors. The processing resources of computer system 900 may be organized into one or more processing units 932, 934, etc. A processing unit may include one or more processors, one or more cores from the same or different processors, a combination of cores and processors, or other combinations of cores and processors. In some embodiments, processing subsystem 904 may include one or more special purpose co-processors such as graphics processors, digital signal processors (DSPs), or the like. In some embodiments, some or all of the processing units of processing subsystem 904 may be implemented using customized circuits, such as application specific integrated circuits (ASICs), or field programmable gate arrays (FPGAs).

In some embodiments, the processing units in processing subsystem 904 may execute instructions stored in system memory 910 or on computer readable storage media 922. In various embodiments, the processing units may execute a variety of programs or code instructions and may maintain multiple concurrently executing programs or processes. At any given time, some or all of the program code to be executed may be resident in system memory 910 and/or on computer-readable storage media 922 including potentially on one or more storage devices. Through suitable programming, processing subsystem 904 may provide various functionalities described above. In instances where computer system 900 is executing one or more virtual machines, one or more processing units may be allocated to each virtual machine.

In certain embodiments, processing acceleration unit 906 may optionally be provided for performing customized processing or for off-loading some of the processing performed by processing subsystem 904 so as to accelerate the overall processing performed by computer system 900.

I/O subsystem 908 may include devices and mechanisms for inputting information to computer system 900 and/or for outputting information from or via computer system 900. In general, use of the term input device is intended to include all possible types of devices and mechanisms for inputting information to computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices that enable users to control and interact with an input device and/or devices that provide an interface for receiving input using gestures and spoken commands. User interface input devices may also include eye gesture recognition devices that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 900 to a user or other computer system. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some embodiments. Storage subsystem 918 may store software (e.g., programs, code modules, instructions) that, when executed by processing subsystem 904, provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes system memory 910 and computer-readable storage media 922. System memory 910 may include a number of memories, including (1) a volatile main random access memory (RAM) for storage of instructions and data during program execution and (2) a non-volatile read only memory (ROM) or flash memory in which fixed instructions are stored. In some implementations, a basic input/output system (BIOS), including the basic routines that help to transfer information between elements within computer system 900, such as during start-up, may typically be stored in the ROM. The RAM typically includes data and/or program modules that are presently being operated and executed by processing subsystem 904. In some implementations, system memory 910 may include multiple different types of memory, such as static random access memory (SRAM), dynamic random access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and operating system 916.

Computer-readable storage media 922 may store programming and data constructs that provide the functionality of some embodiments. Computer-readable media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, DVD, a Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 918 may also include computer-readable storage media reader 920 that may further be connected to computer-readable storage media 922. Reader 920 may receive and be configured to read data from a memory device such as a disk, a flash drive, etc.

In certain embodiments, computer system 900 may support virtualization technologies, including but not limited to virtualization of processing and memory resources. For example, computer system 900 may provide support for executing one or more virtual machines. In certain embodiments, computer system 900 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices.

Communication subsystem 924 may support both wired and/or wireless communication protocols. For example, in certain embodiments, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments, communications subsystem 924 may provide wired network connectivity (e.g., Ethernet) in addition to or instead of a wireless interface.

Communication subsystem 924 may receive and transmit data in various forms. For example, in some embodiments, in addition to other forms, communications subsystem 924 may receive input communications in the form of structured and/or unstructured data feeds 926, event streams 928, event updates 930, and the like. For example, communications subsystem 924 may be configured to receive (or send) data feeds 926 in real-time from users of social media networks and/or other communication services such as web feeds and/or real-time updates from one or more third party information sources.

In certain embodiments, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to communicate data from computer system 900 to other computer systems or networks. The data may be communicated in various different forms such as structured and/or unstructured data feeds 926, event streams 928, event updates 930, and the like to one or more databases that may be in communication with one or more streaming data source computers coupled to computer system 900.

Computer system 900 may be one of various types, including a handheld portable device, a wearable device, a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in the art will appreciate other ways and/or methods to implement the various embodiments.

The processes described herein are each illustrated in a particular order, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a machine-readable storage medium, for example, in the form of a computer program comprising a plurality of instructions executable by one or more processors. The machine-readable storage medium can be non-transitory.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

A number of embodiments of this disclosure have been described. Nevertheless, it will be understood that various modification may be made without departing from the scope of this disclosure.

1. A method for granting a first device permission to use a first messaging application, the method comprising:
receiving, by a remote server from a second device, a confirmation that the second device is executing a second messaging application using a modified library file, wherein the second messaging application and the first messaging application are concurrently logged into an account of a messaging application server, wherein being concurrently logged into the account causes messages sent and received by the first device to be sent to the second device by the messaging application server, and wherein the modified library file is configured to cause the second messaging application to send a communication to the remote server in response to the second messaging application sending or receiving a message; and
in response to receiving the confirmation, granting the first device permission to use the first messaging application.

2. The method of claim 1, further comprising:
in response to determining that the remote server has lost contact with the second device, sending a communication to the first device to cause the first messaging application to be disabled.

3. The method of claim 2, wherein the remote server determines that the remote server has lost contact with the second device when a particular amount of time has passed since the remote server has received a communication from the second device.

4. The method of claim 1, further comprising:
granting the first device temporary permission to use the first messaging application while the second device establishes a connection with the messaging application server, wherein the first device logs into the messaging application server after the temporary permission is granted.

5. The method of claim 1, further comprising:
receiving a request for the modified library file from a proxy server; and
sending the modified library file to the proxy server, wherein receipt of the modified library file by the proxy server causes the proxy server to send the modified library file to the second device to be used by the second device.

6. The method of claim 1, further comprising:
receiving a message from the second device, wherein the received message was sent or received by a device logged into the account.

7. The method of claim 1, wherein the second device is logged into the messaging application server in response to the first messaging application receiving a token from the second device.

8. A system for granting a first device permission to use a first messaging application, the system comprising:
one or more processors; and
a non-transitory computer-readable medium including instructions that, when executed by the one or more processors, cause the one or more processors to:
receive, from a second device, a confirmation that the second device is executing a second messaging application using a modified library file, wherein the second messaging application and the first messaging application are concurrently logged into an account of a messaging application server, wherein being concurrently logged into the account causes messages sent and received by the first device to be sent to the second device by the messaging application server, and wherein the modified library file is configured to cause the second messaging application to send a communication to the system in response to the second messaging application sending or receiving a message; and
in response to receiving the confirmation, grant the first device permission to use the first messaging application.

9. The system of claim 8, wherein the instructions, when executed by the one or more processors, further cause the one or more processors to:
in response to determining that the system has lost contact with the second device, send a communication to the first device to cause the first messaging application to be disabled.

10. The system of claim 9, wherein the system determines that the system has lost contact with the second device when a particular amount of time has passed since the system has received a communication from the second device.

11. The system of claim 8, wherein the instructions, when executed by the one or more processors, further cause the one or more processors to:
grant the first device temporary permission to use the first messaging application while the second device establishes a connection with the messaging application server, wherein the first device logs into the messaging application server after the temporary permission is granted.

12. The system of claim 8, wherein the instructions, when executed by the one or more processors, further cause the one or more processors to:
receive a request for the modified library file from a proxy server; and
send the modified library file to the proxy server, wherein receipt of the modified library file by the proxy server causes the proxy server to send the modified library file to the second device to be used by the second device.

13. The system of claim 8, wherein the instructions, when executed by the one or more processors, further cause the one or more processors to:
receive a message from the second device, wherein the received message was sent or received by a device logged into the account.

14. A non-transitory computer-readable storage medium storing a plurality of instructions executable by one or more processors, the plurality of instructions when executed by the one or more processors cause the one or more processors to:
receive, from a second device, a confirmation that the second device is executing a second messaging application using a modified library file, wherein the second messaging application and a first messaging application are concurrently logged into an account of a messaging application server, wherein being concurrently logged into the account causes messages sent and received by a first device to be sent to the second device by the messaging application server, wherein the modified library file is configured to cause the second messaging application to send a communication to a remote server in response to the second messaging application sending or receiving a message, and wherein the remote server includes the one or more processors; and
in response to receiving the confirmation, grant the first device permission to use the first messaging application.

15. The non-transitory computer-readable storage medium of claim 14, wherein the plurality of instructions when executed by the one or more processors further cause the one or more processors to:
in response to determining that the remote server has lost contact with the second device, send a communication to the first device to cause the first messaging application to be disabled.

16. The non-transitory computer-readable storage medium of claim 15, wherein the remote server determines that the remote server has lost contact with the second device when a particular amount of time has passed since the remote server has received a communication from the second device.

17. The non-transitory computer-readable storage medium of claim 14, wherein the plurality of instructions when executed by the one or more processors further cause the one or more processors to:
grant the first device temporary permission to use the first messaging application while the second device establishes a connection with the messaging application server, wherein the first device logs into the messaging application server after the temporary permission is granted.

18. The non-transitory computer-readable storage medium of claim 14, wherein the plurality of instructions when executed by the one or more processors further cause the one or more processors to:
receive a request for the modified library file from a proxy server; and
send the modified library file to the proxy server, wherein receipt of the modified library file by the proxy server causes the proxy server to send the modified library file to the second device to be used by the second device.

19. The non-transitory computer-readable storage medium of claim 14, wherein the plurality of instructions when executed by the one or more processors further cause the one or more processors to:
receive a message from the second device, wherein the received message was sent or received by a device logged into the account.

20. The non-transitory computer-readable storage medium of claim 14, wherein the second device is logged into the messaging application server in response to the first messaging application receiving a token from the second device.

21.-60. (canceled)
